(19) United States
(12) Patent Application Publication
(10) Pub. No.: US 2026/0247189 A1
(43) Pub. Date: Aug. 20, 2026

(54) METHODS, ARCHITECTURES, APPARATUSES AND SYSTEMS FOR WAVEFORM PROCESSING FOR SENSING

(71) Applicant: InterDigital Patent Holdings, Inc., Wilmington, DE (US)

(72) Inventors: Ibrahim Hemadeh, Hemel Hempstead (GB); Yasser Mestrah, London (GB); Arman Shojaeifard, London (GB); Javier Lorca Hernando, Madrid (ES); Alain Mourad, Ascot (GB); Mohammed El-Hajjar, Southampton (GB); Pankaj Kumar, Southampton (GB)

(21) Appl. No.: 19/054,654

(22) Filed: Feb. 14, 2025

(51) Int. Cl. H04W 24/10; H04L 5/00; H04W 72/231

(52) U.S. Cl. CPC H04W 24/10; H04L 5/0051; H04W 72/231

(57) ABSTRACT

Methods and systems are provided for waveform processing for sensing with a wireless network, and more particularly, with a wireless transmit/receive unit (WTRU). The WTRU receives, from a wireless network, first sensing configuration information for a sensing measurement, wherein the first sensing configuration information indicates a first type of waveform processing. The WTRU performs sensing measurements based on the first type of waveform processing to generate data first measurement report and transmit, to the wireless network, the first measurement report. After transmitting the first measurement report, the WTRU receives, from the wireless network, second sensing configuration information indicating a second type of waveform processing. The WTRU perform sensing measurements based on the second type of waveform processing to generate a second measurement report and the WTRU transmit, to the wireless network, the second measurement report.

### TECHNICAL FIELD

The present disclosure is generally directed to the fields of communications, software and coding, including, for example, to methods, architectures, apparatuses, systems related to performing sensing.

### BACKGROUND

Unlike communication data transmission in a wireless network, sensing focuses on estimating and detecting target characteristics (e.g., range, velocity) from reflected signals. Orthogonal Frequency Division Multiplexing (OFDM), while widely used, presents design limitations for sensing, as its fixed sub-carrier spacing restricts achievable time and range resolutions, impacting sensing accuracy. Therefore, there exists a need for a framework for sensing applications.

### SUMMARY

The present disclosure relates to method and systems for performing sensing with a wireless network, and more particularly, with a wireless transmit/receive unit (WTRU). The WTRU receives configuration information indicating measurement resources, waveform processing details, and reporting criteria. By performing measurements on reference signals and reporting them to a network, the WTRU may provide optimal waveform processing types and parameters for future transmissions. The network may then reconfigure the WTRU with updated waveform processing, allowing the WTRU to perform further measurements and provide feedback, ultimately improving communication performance.

In certain representative embodiments, methods and systems are provided for waveform processing for sensing. The methods and systems may include a WTRU receiving, from a wireless network, first sensing configuration information for a sensing measurement, wherein the first sensing configuration information indicates a first type of waveform processing. The WTRU performing sensing measurements based on the first type of waveform processing to generate a first measurement report. The WTRU transmitting, to the wireless network, the first measurement report. After transmitting the first measurement report, receiving, from the wireless network, second sensing configuration information indicating a second type of waveform processing. The WTRU performing sensing measurements based on the second type of waveform processing to generate a second measurement report and transmitting, to the wireless network, the second measurement report.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is an illustrative diagram depicting waveform processing to improve sensing accuracy, in accordance with certain embodiments;

FIG. 3 is an illustrative diagram depicting waveform processing and de-processing within transmitter and receiver chains, in accordance with certain embodiments;

FIG. 4 is an illustrative diagram depicting a waveform processing applied to a portion of a transmitted signal, in accordance with certain embodiments;

FIG. 5 is an illustrative diagram depicting channel response peaks of two targets, in accordance with certain embodiments;

FIG. 6 is an illustrative a chart that depicts the average RMSE of range estimation for multiple systems that employ waveform processing, in accordance with certain embodiments;

FIG. 7 is an illustrative diagram depicting wavelet waveform processing of an OFDM-based signal, in accordance with certain embodiments;

FIG. 8 is an illustrative example of a sensing measurement using a configuration, in accordance with certain embodiments;

FIG. 9 is an illustrative example of a sensing measurement using a sensing configuration, in accordance with certain embodiments; and

FIG. 10 illustrates a method for waveform processing for sensing in accordance with certain embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

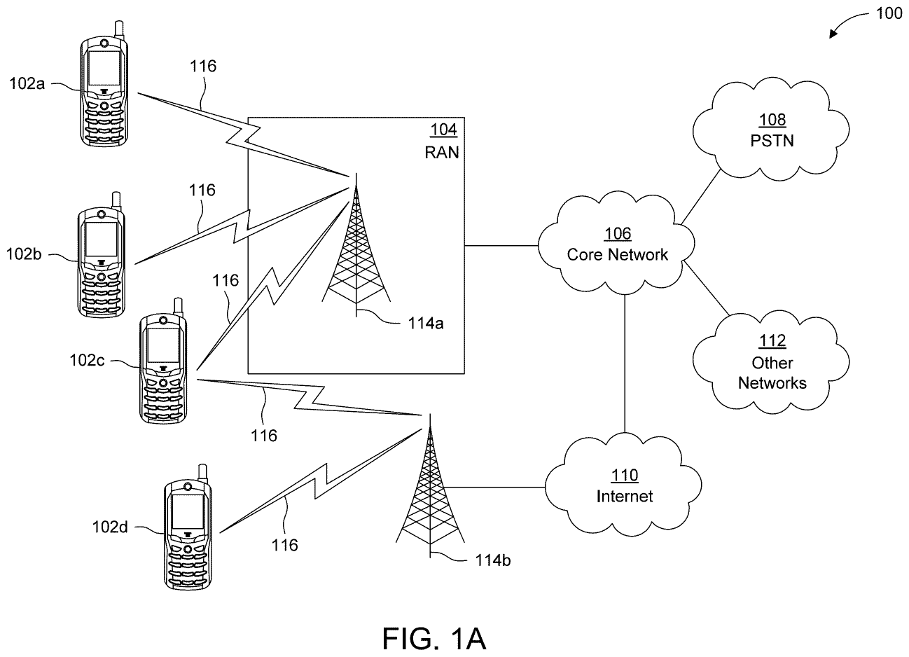

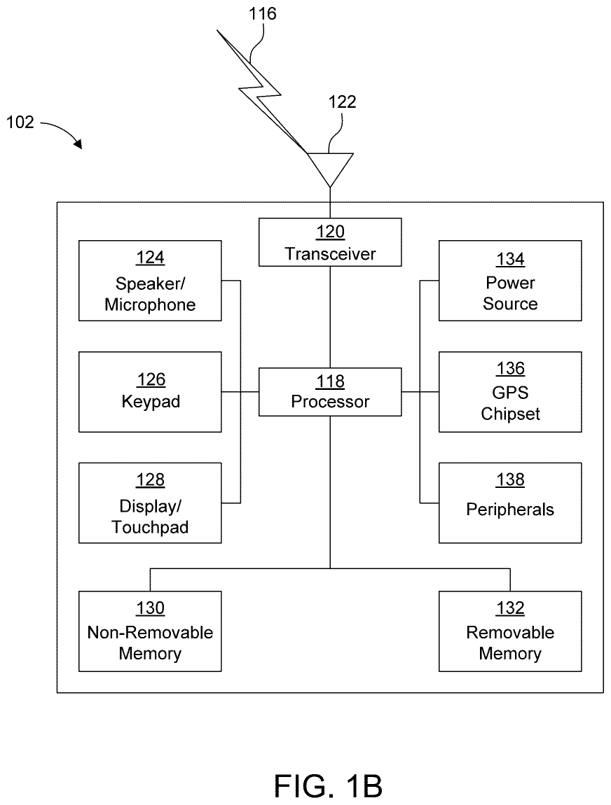

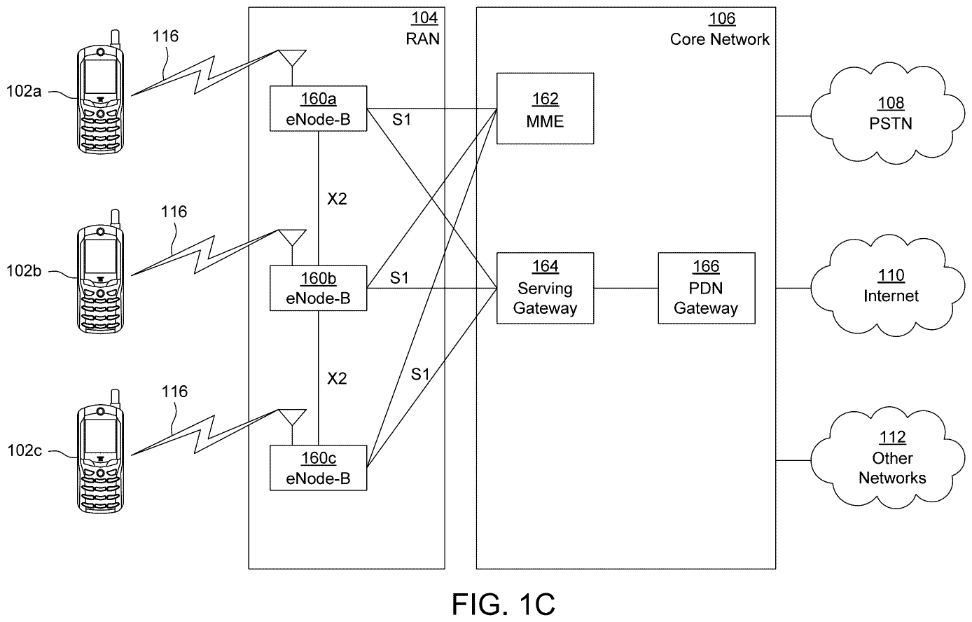

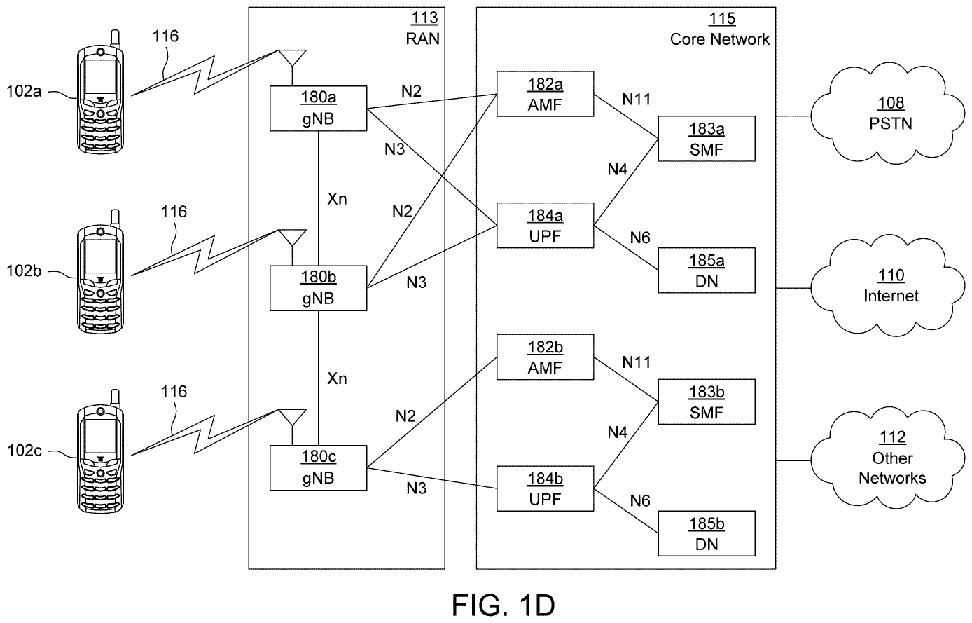

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

It will be understood that a wireless network may include any suitable components and devices, including, for example, any of one or more base stations, one or more TRPs, one or more gNBs, one or more WTRUs, any other suitable device or component, or any combination thereof. It will be further understood that a component or device that is part of the wireless network can be referred to as communicating with the wireless network when it is communicating with any one or more other components or devices of the wireless network. For example, reference to a WTRU, which is part of the wireless network, transmitting or receiving signals to or from the wireless network refers to the WTRU transmitting or receiving signals, respectively, to or from any other component or device (e.g., another WTRU) of the wireless network.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network. In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, orthogonal frequency division multiplexing (OFDM) symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

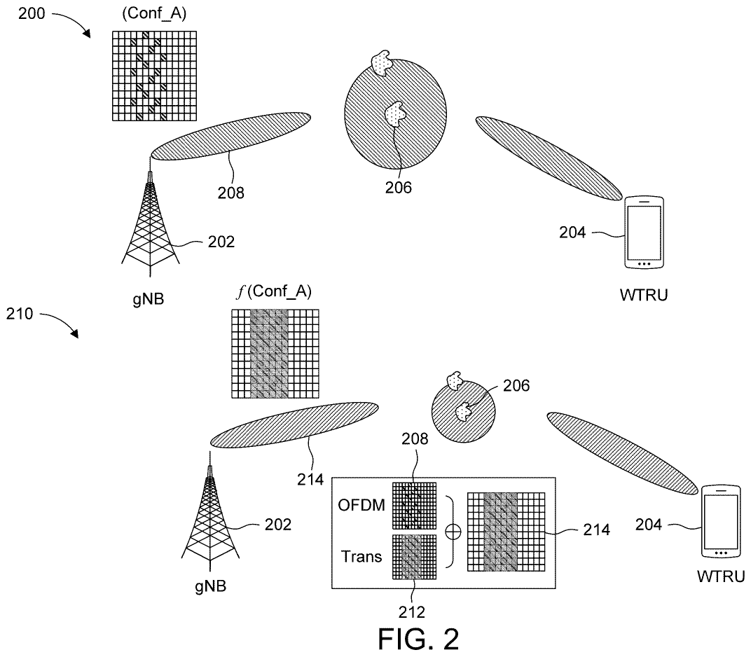

In certain embodiments of the present disclosure, including those described below at least in connection with FIGS. 2-10, the devices, systems, architectures, communication links, apparatuses, and other elements depicted in FIGS. 1A-1D may be used in connection with waveform processing for sensing.

The waveform design for new radio (NR) primarily relies on cyclic prefix-orthogonal frequency division multiplexing (CP-OFDM) for both downlink (DL) and uplink (UL) transmission, with discrete Fourier transform-spread-orthogonal frequency division multiplexing (DFT-s-OFDM) also supported in the UL coverage-limited scenarios. In connection with communications, NR adopts CP-OFDM with flexible numerology to prioritize backward compatibility while also improving communications performance. For example, CP-OFDM may be adopted to improve at least one of the following performing metrics: data rate, reliability, error rate, time-frequency resource allocation, combinations of the same, or the like. Waveform design for sensing tasks (e.g., detection of targets, tracking of targets, environmental monitoring, environmental reconstruction, or the like) requires consideration of a different set of performance metrics. For example, waveform design for sensing tasks may require consideration of at least one of the following performance metrics: sensing accuracy, range resolution, velocity resolution, combinations of the same, or the like.

In orthogonal frequency division multiplexing (OFDM) approaches, symbols are modulated in the frequency domain and transmitted in the time domain, e.g., after applying an inverse discrete Fourier transform (IDFT). OFDM approaches may offer sufficient flexibility and spectral efficiency for many communication systems. In such approaches, a cyclic prefix may be added to each OFDM symbol to overcome the inter-symbol interference introduced in a dispersive multipath fading channel.

In connection with sensing, waveform performance may be characterized with at least one of the following metrics: resolution (e.g., range resolution, velocity resolution, or the like); unambiguous range; peak-to-average power ratio (PAPR); combinations of the same; or the like. OFDM approaches may provide adequate range resolution and frequency diversity performance, but offer limited velocity resolution and unambiguous range. Additionally, such approaches may suffer from high PAPR, and may be sensitive to phase noise and frequency offset in high mobility scenarios.

In connection with sensing, key performance indicators (KPIs) may include at least one of the following: resolution (e.g., range resolution, velocity resolution, angular resolution, or the like); peak-to-sidelobe ratio; delay ambiguity; doppler ambiguity; maximum unambiguous range; maximum unambiguous velocity; ranging estimation accuracy; combinations of the same; or the like.

Unlike communications tasks, sensing tasks include an estimation and detection problem, where no user data is decoded. In such sensing tasks, sensing information is extracted from received signals that are reflected from one or more sensing targets. In some embodiments, sensing information may include at least one of: a delay, a range resolution, a velocity estimation, combinations of the same, or the like.

The main drawback of OFDM approaches lies in a design limitation, e.g., a particular sub-carrier spacing to achieve a particular time resolution and range resolution. This design limitation may have a direct impact on the performance of a sensing task, e.g., by decreasing the accuracies of range and velocity estimation.

A processing may be introduced to the sensing signal to overcome such drawbacks, e.g., to improve sensing accuracy. In some embodiments, the processing may be introduced by applying a transformation (e.g., wavelet transformation) to the sensing signal, which may focus the sensing on a single dimension (e.g., frequency, time, or the like). Accordingly, a framework that enables the tuning of the OFDM waveform characteristics for sensing is provided.

FIG. 2 is an illustrative diagram depicting waveform processing to improve sensing accuracy, in accordance with certain embodiments.

As shown in scenario 200 of FIG. 2, a DL reference signal (RS) (e.g., a positioning reference signal (PRS)) 208 using a configuration Conf_A may be transmitted by a network entity (e.g., gNB 202) to a WTRU 204 for detection of multiple targets 206 and may not achieve a desired range resolution. As shown in scenario 210 of FIG. 2, the DL reference signal 208 may be processed by applying a processing function f(·) to the configuration Conf_A, e.g., by applying a transformation 212 to the OFDM waveform of DL reference signal 208. The resultant processed signal 214 may be transmitted by the network entity (e.g., gNB 202) to the WTRU 204 for detection of a single target of the multiple targets 206, improving the sensing task performance.

In accordance with certain embodiments of the present disclosure, systems and methods for the tuning of the transceiver chain for sensing applications are described as follows. For example, a receiver (e.g., a WTRU) may perform sensing measurements using a first set of RSs and extract a set of meaningful channel information (e.g., time domain, information, frequency domain information, or the like). Further, for example, the channel information may include the sensing accuracy levels and/or the peaks of the received signal after fast Fourier transform (FFT) and/or inverse fast Fourier transform (IFFT). Moreover, for example, the receiver (e.g., the WTRU) may identify and report a preferred waveform processing, e.g., altering the current waveform with wavelet transform, Walsh-Hadamard transform (WHT), Hilbert-Huang transform (HHT), combinations of the same, or the like. Additionally, for example, the transmitter (e.g., the network entity) may configure and apply the selected waveform processing and transmit a second set of (e.g., processed) RSs. Also, for example, the receiver may perform sensing measurements of the second set of RSs (e.g., with waveform processing), whereby the tuning of the OFDM transceiver chain leads to improved sensing performance.

In the present disclosure, we describe a downlink scenario, however, the systems and methods are also applicable to UL and sidelink (SL) scenarios.

In certain representative embodiments, systems and methods for waveform processing of sensing signals include at least one of the following steps: receiving a first configuration including first sensing configuration information that indicates one or more waveform transformations;
performing measurements of a first set of received RSs based on the one or more waveform transformations; sending a first report indicating a waveform processing to be used in future RS transmissions; receiving a second configuration including second sensing configuration information that indicates a second one or more waveform transformations; performing measurements of a second set of received RSs based on the second one or more waveform transformations; reporting the measurements of the second set of received RSs; combinations of the same; or the like.

In some embodiments, the WTRU may receive a first configuration (e.g., using radio resource control (RRC), medium access control-control element (MAC-CE), downlink control information (DCI), or the like) that includes first sensing configuration information. For example, the first sensing configuration information may include one or more waveform transformations to be used for sensing measurement events, triggers, and reports. Further, for example, the first configuration may include at least one of the following: WTRU measurement resources; a first set of RSs (e.g., PRSs); sensing methods (e.g., channel-based sensing methods); transformation-specific measurements and associations; WTRU waveform processing information; WTRU measurement events and triggers; WTRU reporting mechanisms and behaviors; combinations of the same or the like.

In some embodiments, transformation-specific measurements and associations may include at least one of the following: association of peaks and/or measurements between different waveform transforms; waveform processing-related measurements (e.g., measured energy), e.g., to aid in waveform transformation selection; priority and/or ordering of dimensions for sensing (e.g., frequency vs. time, delay vs. doppler, or the like); a set of supported waveform transformations (e.g., types and parameters including range), e.g., for the WTRU to dynamically select based on scenario-specific requirements; combinations of the same; or the like.

In some embodiments, WTRU waveform processing information may indicate a type of waveform transformation and/or parameters associated with one or more transformations. Further, for example, WTRU waveform processing information may include at least one of the following: waveform processing configuration, e.g., waveform design aspects; waveform processing type, e.g., wavelet, WHT, HHT, or the like; waveform processing measurements; waveform transform-specific measurements, e.g., wavelet energy bins; combinations of the same; or the like. Also, for example, waveform design aspects may include at least one of an ambiguity function, autocorrelation function, combinations of the same, or the like. Moreover, for example, waveform processing measurements may include at least one of: delay-doppler measurements; root mean squared error (RMSE) measurements; peak detection methods (e.g., number of peaks, peaks window, delay difference between peaks, or the like); combinations of the same; or the like.

In some embodiments, the WTRU measurement events and triggers may impact sensing measurement in connection with activating, deactivating, and/or modifying waveform transformation. Further, for example, the WTRU measurement events and triggers may include at least one of the following: a measurement event is above or below a threshold, e.g., RMSE is above a threshold; a sensing measurement accuracy (e.g., range, velocity) is below a threshold; peaks measurements after processing are below a threshold, e.g., channel impulse response (CIR) peaks are below a threshold; peak-to-sidelobe ratio are below a threshold; a change in signal difference peaks after applying FFT and/or IFFT; combinations of the same; or the like.

In some embodiments, WTRU reporting mechanisms and behaviors may indicate procedures for WTRU explicit or implicit reporting and may include at least one of the following: basic sensing measurements (e.g., post-processing delay, doppler, range, and/or RMSE values); waveform-specific metrics, e.g., wavelet energy bins; an indication of a preferred one or more waveform transformations; an association of peaks and/or measurements between reports associated with different measurements; combinations of the same; or the like.

In some embodiments, the WTRU may perform a first set of measurements on a first set of received RSs based on one or more (e.g., of the configured) waveform transformations. In some embodiments, the first set of measurements may include at least one of the following: peak measurements, e.g., CIR peaks, power delay profile (PDP) peaks; peak windows; transmitted-to-received signal difference peaks for range and doppler, e.g., after applying FFT and/or IFFT; one or more windows of signal difference peaks, e.g., after applying FFT and/or IFFT; correlations and/or associations (e.g., time-delay, energy, Doppler shifts) between different waveform transforms (e.g., CIRs from FFT, wavelet, or WHT); combinations of the same; or the like. For example, peak windows may include at least one of the following: one or more time windows of received peaks (e.g., limiting outliers for interference); one or more frequency windows of received peaks (e.g., for improved doppler estimation); one or more doppler windows of received peaks (e.g., for speed related information); combinations of the same; or the like.

In some embodiments, the WTRU may determine a waveform processing to be used in future transmissions (e.g., by the network) and sends a first report indicating the determined waveform processing. In some embodiments, the WTRU determines the waveform processing and sends the first report at a configured time and/or in response to identifying a trigger (e.g., sensing accuracy falling below a threshold). For example, the first report may include at least one of the following: key sensing metrics, e.g., delay, doppler, achieved accuracies, lobe information, or the like; waveform processing suggestions, e.g., introduce wavelet transformation with a corresponding configuration (e.g., wavelet function, up-sampling rate, or the like); measurement associations across different waveform transformations, e.g., matched peaks, detected ambiguities, or the like; combinations of the same; or the like. Further, for example, each waveform transformation may have its own focus domain.

In some embodiments, the WTRU may receive (e.g., via RRC, MAC-CE, DCI, or the like) a second configuration that includes second sensing configuration information. For example, the second sensing configuration information may include one or more waveform transformations to be used for sensing events, measurements, triggers, and reports. In some embodiments, the second sensing configuration information is independent of (e.g., indicating different waveform transformations to) the information of the first report sent by the WTRU. For example, the second configuration may include at least one of the following: new and/or updated information regarding one or more applied waveform transformations; parameters for measurements, e.g., time window, set of sub-carriers, time-frequency resources, or the like; reporting rules; triggering rules for activating, modifying, and/or deactivating specific waveform processes; new and/or updated information, e.g., regarding association between transformations and/or priority dimensions or using cross-domain metrics (e.g., delay-energy mapping); combinations of the same; or the like.

In some embodiments, the WTRU may perform a second set of sensing measurements on a second set of received RSs based on configured waveform transformations, measurement events, triggers, and/or reports. For example, the WTRU may perform the second set of sensing measurements based on at least one of the following: applying waveform de-processing (e.g., inverse wavelet, WHT, HHT, or the like); sensing measurements (e.g., range, velocity, or the like) and their corresponding accuracies and/or certainties; environmental indicators (e.g., blockage, environmental objects, or the like); power peaks (e.g., peak CIR, PDPs, or the like); waveform-specific measurements (e.g., energy bins of wavelet-based received signal) or other frequency, time, and/or space specific measurements; comparative analysis between the first and second configuration, e.g., assessing improvement and/or degradation through analysis of peak alignment and/or doppler consistency; combinations of the same; or the like.

In some embodiments, the WTRU may report the second measurements of the second set of received RSs. For example, the WTRU may include at least one of the following in the reporting: sensing measurements (e.g., delay, doppler, RMSE, peaks, or the like); improvement metrics (e.g., updated accuracies, certainties, time window, power peaks), e.g., comparative improvement metrics between the first and second configurations; correlations between sensing measurements and the applied waveform processing, e.g., the impact of specific wavelet configurations or scaling factors on sensing results; associations between the sensing measurements and waveform processes, e.g., including how different processes (e.g., FFT and wavelet transformations) contributed to refining key metrics; anomalies and/or deviations, e.g., inconsistencies or unexpected trends in the measurements; waveform-specific measurements (e.g., wavelet-specific measurements); combinations of the same; or the like. In some embodiments, the WTRU reports the improved delay accuracy from a composite of two or more processes (e.g., waveform transformations). Further for example, reported anomalies and/or deviations may include missed peaks and/or environment dynamics. Moreover, for example, waveform-specific measurements may include wavelet energy bins (e.g., time-frequency power distribution) and/or sensing significance measurements. Also, for example, sensing significance measurements may include the energy portion used for sensing, e.g., one or more energy bins that contribute the most to the sensing measurement.

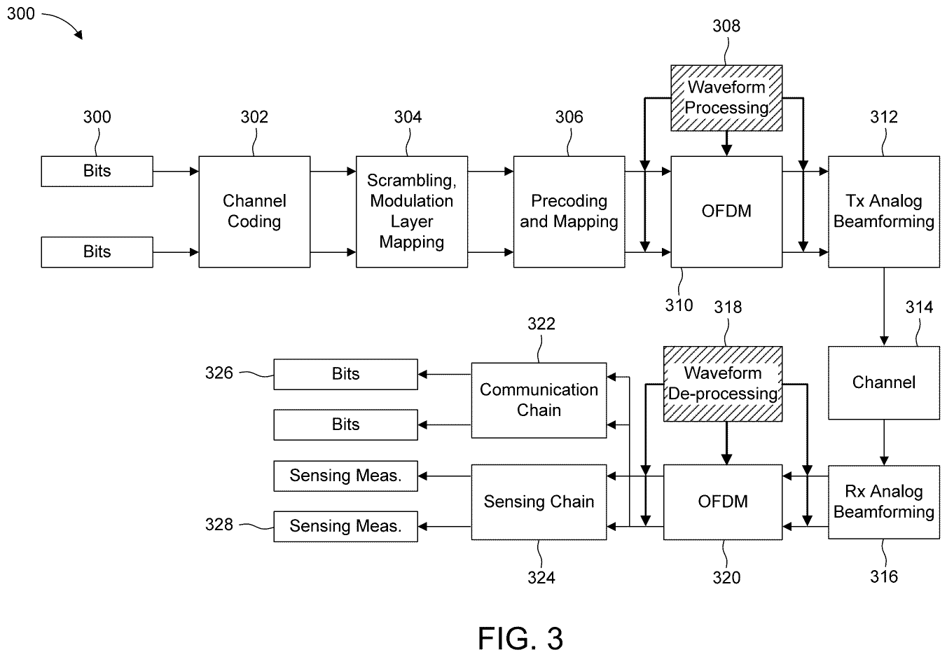

FIG. 3 is an illustrative diagram depicting the location of waveform processing and de-processing within the transmitter and receiver chains, in accordance with certain embodiments. Atransmitter path may include a Channel Coding 302, a Scrambling, Modulation and Layer Mapping 304, a Precoding and Mapping 306, an OFDM Module 310, and a Tx Analog Beamforming module 312 for processing input bits 300 and transmitting a signal over a channel 314. A receiver path may include an Rx Analog Beamforming module 316, an OFDM module 320, and a Waveform De-Processing 318 for receiving the signal and generating output bits 326. A Waveform Processing 308 may be provided at the transmission side. The reception chain may include a communication chain 322 and sensing chain 324 for processing sensing measurements 328 and generating bits for transmission.

In accordance with certain embodiments of the present solution, WTRU capability information is described as follows.

In certain representative embodiments, the WTRU may use existing mechanisms to inform the network of its waveform processing capabilities. For example, the WTRU may receive and decode a first capability request (e.g., via RRC) following the random-access procedure. Further, for example, the WTRU capability information may include at least one of the following waveform processing capabilities: supported processing types, e.g., waveform processing and/or transformations; available processing transformations and corresponding parameters, e.g., Fourier transformations (e.g., IFFT and/or FFT), wavelet transformations, WHT, HHT, or the like; multi-transform processing, e.g., capability to switch between or combine multiple transformations; waveform-related capabilities, e.g., bandwidth, sub-carrier ranges, waveform resolutions (e.g., spatial, time, frequency, doppler, angular); information about hardware required for waveform processing, e.g., additional oscillators; support for a set of reference symbols for waveform-related measurements.

In accordance with certain embodiments of the present disclosure, WTRU configuration information is described as follows.

In certain representative embodiments, the WTRU may receive a first configuration with one or more waveform transformations to be used for sensing measurement events, triggers, and/or reports.

In connection with applying one or more waveform transformations for sensing applications, communication of configuration information (e.g., including protocols) is important for maintaining synchronization between the WTRU and the network (e.g., in DL and UL transmission) and between multiple WTRUs (e.g., in SL transmission). For example, the configuration may be signaled through RRC, MAC-CE, and DCI.

In some embodiments, the WTRU may provide high-level, semi-static configurations for waveform transformations using RRC. For example, the configurations may be used to define sensing tasks, RSs, and waveform parameters (e.g., type, resolution, time-frequency resources, or the like). Further, for example, the configurations may be used to set thresholds for sensing triggers (e.g., energy bin levels, RMSE, or the like). Moreover, for example, in DL transmission, RRC may be used to configure DL RSs for sensing and specify a waveform processing method (e.g., FFT, wavelet, or the like). Additionally, for example, in UL transmission, RRC may be used to configure signals generated by the WTRU (e.g., sounding reference signals (SRS)) for UL sensing by the network (e.g., gNB) in addition to waveform parameters for UL signal generation, e.g., frequency scaling and/or energy bins. Also, for example, in SL transmission, RRC may be used to configure sideline-specific sensing (e.g., over a physical sidelink shared channel (PSSCH)) for peer-to-peer operation and assign sensing priorities and/or transformation types for sensing over SL channels.

In some embodiments, the WTRU may use MAC-CE to communicate real-time updates to waveform transformations and sensing configurations (e.g., based on network conditions). For example, in DL transmission, MAC-CE may be used to update parameters for DL sensing tasks, e.g., modifying PRS, adjusting detection thresholds, activating and/or deactivating waveform transformations for specific time and/or frequency windows, or the like. Further, for example, in UL transmission, MAC-CE may be used to dynamically modify SRS transmission settings (e.g., bandwidth, periodicity, or the like) to improve sensing granularity and adjust sensing thresholds for UL measurements, e.g., power levels, peak detection limits, or the like. Moreover, for example, in SL transmission, MAC-CE may be used to activate and/or deactivate SL resources (e.g., resource blocks) and additionally to adjust waveform-specific parameters. In some embodiments, MAC-CE is used in SL transmission to modify sensing thresholds for detecting WTRU positions.

In some embodiments, the WTRU may use DCI for low-latency control of sensing tasks, by allocating resource dynamically and overriding RRC and/or MAC-CE when immediate changes are required. For example, in DL sensing, DCI may be used to make changes to the resources used and configure specific transformations. For example, in UL sensing, DCI may be used to grant UL resources and modify waveform parameters in real time. Similarly, for example, DCI may be used to control the resource for peer-to-peer sensing in SL sensing.

For example, the WTRU may signal a configuration (e.g., over RRC, MAC-CE, DCI, or the like) including at least one of: reference signal information for sensing, e.g., channel state information-reference signal (CSI-RS), PRS, or the like; raw sensing measurements to be performed, e.g., measurements related to the received signal; processed sensing measurements to be performed, e.g., range, velocity, or the like; validation measurements, e.g., certainties (e.g., angle of arrival (AoA) certainty, time of arrival (ToA) certainty), sensing accuracies (e.g., ranging accuracy, velocity accuracy), Cramer-Rao lower bound (CRLB), or the like; sensing methods (e.g., time-based, angle-based, power-based, channel-based, waveform-based, or the like); priority and/or ordering of dimensions for sensing (e.g., frequency vs. time, delay vs. Doppler); a set of support transformations (e.g., including a type and/or parameters including range) for the WTRU to dynamically select based on scenario-specific requirements; associations of peaks and/or measurements between different waveform transformations; WTRU waveform processing information, e.g., including type and/or associated parameters for one more transformations; triggers (e.g., triggering events) for altering the waveform transformation; WTRU reporting mechanisms and behavior; WTRU reporting content; combinations of the same; or the like.

In some embodiments, the configuration may indicate reference signals to be used to determine and/or obtain measurements for sensing tasks or/and waveform processing.

In some embodiments, the raw sensing measurements may include at least one of angular measurements, delay measurements, power measurements, doppler measurements, radar cross-section (RCS) measurements, combinations of the same, or the like. Further, for example, the raw sensing measurements may include at least one of the following metrics: AoA, ToA, signal to noise ratio (SNR), reference signal received power (RSRP), combinations of the same, or the like.

In some embodiments, WTRU waveform processing information may include at least one of the following: a waveform processing type, e.g., wavelet, WHT, HHT, or the like; waveform processing characteristics, e.g., wavelet function; waveform processing measurements, e.g., delay-doppler measurements, RMSE measurements, peak detection methods, or the like; waveform-specific measurements, e.g., wavelet energy bins defined as the time-frequency power distribution; combinations of the same; or the like.

In some embodiments, triggers for altering transformation of the waveform may include at least one of the following: a certainty for each sensing metric (e.g., ToA, AoA, SNR, RSRPP, or the like) is below a threshold (e.g., thresh_i for the i-th metric); a sensing measurement accuracy (e.g., range accuracy, velocity accuracy, or the like), is below a threshold; location-based information, e.g., locations type, environmental objects information, or the like; mobility measurements are below or above a threshold, e.g., target or WTRU velocity is above or below a threshold; ranging measurements are below or above a threshold, e.g., ranging measurements are above the maximum unambiguous range; peak measurements are below a threshold, e.g., CIR peaks are below a threshold; a number of peaks is above or below a threshold; a difference between the delays of different peaks is above or below a threshold; a domain resolution (e.g., time resolution, doppler resolution, frequency resolution, power resolution, angular resolution, or the like) is above or below a threshold; a peak-to-sidelobe ratio is below a threshold; a difference between the main lobe and the first sidelobe is above a threshold; transmitted-to-received signal mapping peaks, e.g., IFFT peak indices to detect range and FFT peak indices to detect velocities, are below a threshold (e.g., thres_5); an unidentified RCS profile; an unidentified CIR profile, e.g., including unidentified multipath component measurements; combinations of the same; or the like.

In some embodiments, WTRU reporting mechanisms and behavior may include at least one of the following: explicit reporting with a physical uplink control channel (PUCCH) for compact periodic or event-driven reporting; explicit reporting with a physical uplink shared channel (PUSCH) for more extensive reports, e.g., including waveform-specific measurements; implicit reporting though UL resource selection (e.g., specific physical resource blocks (PRBs)), power control feedback, beam selection, hybrid automatic repeat request (HARQ) timing behavior, or the like;

In some embodiments, WTRU reporting content may include at least one of the following: basic sensing measurements, e.g., delay, doppler, range, or the like; waveform-specific metrics, e.g., wavelet energy bins, correlations and/or associations between measurements from different transformations, or the like; an indication of one or more preferred transformations (e.g., types and/or associated parameters); combinations of the same; or the like. For example, the WTRU may directly indicate the preferences (e.g., wavelet transformations) using signaling (e.g., bits in the uplink control information (UCI)). Further, for example, the WTRU may use indices from a pre-defined look-up table. Moreover, for example, the WTRU may provide new metrics that evaluate and rank different transformations according to a certain set of KPIs (e.g., to assess energy efficiency). Additionally, for example, the WTRU may provide correlations between information from a first transformation and a second transformation (e.g., association of two CIRs).

Table 1 provides an illustrative example of a set of waveform processing techniques, e.g., waveform transformations, and corresponding characteristics. The WTRU may be configured with Fourier transform, WHT, wavelet transform, and/or HHT as described in Table 1.

TABLE 1

| | Fourier | Walsh-Hadamard | Wavelet | Hilbert-Huang |
|---|---|---|---|---|
| | transform | transform (WHT) | transform | transform (HHT) |
| Basic function | Pre-selected | Pre-selected | Pre-selected | Adaptive |
| | (e.g., sine) | (e.g., square) | (e.g., wavelet) | (e.g., intrinsic mode |
| | | | | function (IMF)) |
| Non-linear | No | No | No | Yes |
| signal | | | | |
| Instant | Convolution with | Convolution with | Convolution with | Derivation of |
| frequency | basic functions | basic functions | basic functions | phase function |
| calculation | | | | |
| Instant | Global | Global | Regional | Local |
| frequency | | | | |
| Feature | Frequency | Frequency | Time-frequency | Time-frequency |

In some embodiments, the waveform processing is applied (e.g., to the RS) using at least one of the following options: using a new transformation, e.g., switching from FFT/IFFT to another transformation like wavelet, WHT, or HHT; mixing one of the available transformations with the OFDM signal; combinations of the same; or the like.

In some embodiments, the WTRU may mix the transformation with the OFDM signal in the frequency domain (e.g., prior to the IFFT transformation), e.g., applying the transformation to a set of sub-carriers. Further, for example, the WTRU may mix the transformation with the OFDMM signal in the time domain, e.g., applying the transformation to a time portion of the OFDM signal.

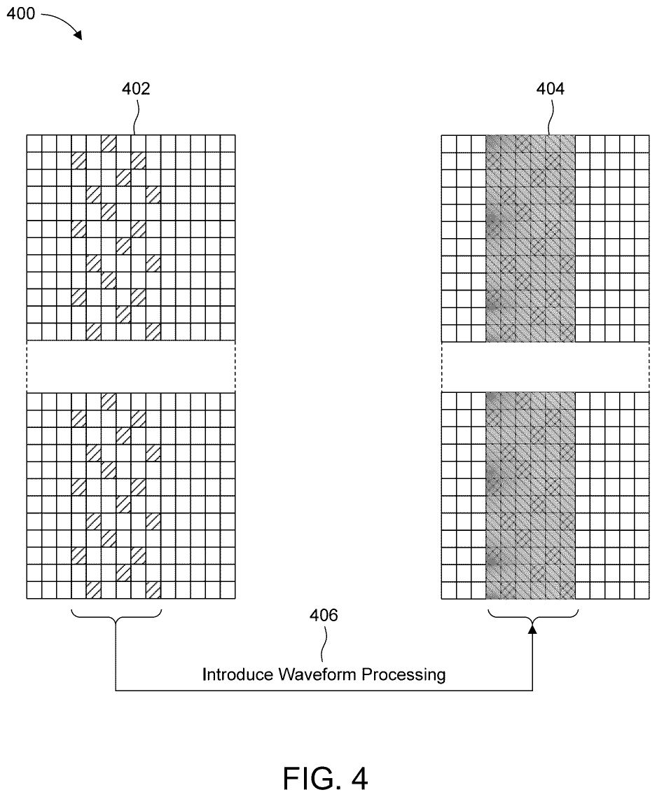

FIG. 4 is an illustrative diagram depicting a waveform processing applied to a portion of a transmitted signal, in accordance with certain embodiments.

As shown in FIG. 4, in some embodiments, the waveform processing 406 is applied to a set of time-frequency resources (e.g., a set of PRBs configured with a set of PRS 402), resulting in a processed set of time-frequency resources (e.g., a set of PRBs configured with a set of processed PRS 404). For example, the time and frequency information about where the processing is applied, may require to be known to the WTRU, e.g., including the set of OFDM symbols and associated time-frequency resources.

In accordance with certain embodiments of the present disclosure, measurements for waveform processing are described as follows.

In certain representative embodiments, the WTRU receives a first set of RSs that are dedicated for sensing. For example, in DL transmission, the first set of RSs may include at least one of: PRSs, CSI-RSs, synchronization signal blocks (SSBs), demodulation reference signals (DMRSs), or the like. Further, for example, in UL transmission, the first set of RSs may include at least one of SRSs, DMRSs, WTRU-specific RSs (e.g., chirp-implementation), or the like. Moreover, for example, in UL transmission, the first set of RSs may include DMRSs, CSI-RSs, SRSs, or the like.

In some embodiments, the WTRU may be configured by the network to perform measurements using a first set of RSs. For example, the WTRU may perform these measurements based on any set of configured waveform transformations using allocated time, frequency, and space resources, e.g., including the start and end time of the sensing window, the duration, and the associated periodicity. Further, for example, the WTRU may obtain at least one of the following measurements: received and/or reflected signal measurements (e.g., AoA, ToA, time difference of arrival (TDoA), absolute and/or relative reference signal received power per path (RSRPP) or RSRP, SNR, doppler, RCS, or the like); one or more channel responses in the time domain, frequency domain, and/or angular domain (e.g., CIR, channel frequency response (CFR)) and their corresponding power profiles (e.g., PDP); peaks, e.g., measurements corresponding to the most significant multipath components; a transmitted-to-received signal difference, e.g., division of the received signal by the transmitted signal in order to obtain the range-doppler representation; signal difference peaks after applying FFT and/or IFFT; a window over which the signal difference peaks were determined after applying FFT and/or IFFT; waveform-specific measurements, e.g., wavelet-specific measurements; associations between the target measurements and the one or more waveform processing adopted, e.g., an association between a target sensing measurement and wavelet configuration, wavelet function, and/or scaling factor; correlations and/or associations (e.g., of time-delay, energy, doppler shifts) between different waveform transformations, e.g., a correlation between CIRs obtained from FFT and CIRs obtained from wavelet transform; peak alignment and/or doppler consistency to assess improvement and/or degradation; combinations of the same; or the like.

In some embodiments, the WTRU may determine peaks (e.g., of the CIR or PDP) based on at least one of the following: delay; frequency; doppler; combinations of the same; or the like. Also, for example, the WTRU may determine the peaks of the CIR or PDP. Further, for example, the WTRU may obtain peak measurements including at least one of the following: a value of each peak, e.g., values of peaks above a threshold; a number of peaks above a threshold; a time window over which the peaks are obtained, e.g., CIR peaks in the time domain, CFR peaks, and/or PDP peaks of a portion of the received set of symbols (e.g., set of received resource blocks (RBs) over multiple antenna ports); a delay difference between different peaks; combinations of the same; or the like.

In some embodiments, the WTRU may determine a transmitted-to-received signal difference S_{diff} based on the following equation:

$${S}_{d i f f} = \frac{{S}_{R x}}{{S}_{T x}} \approx f ( ε , {f}_{d} , R )$$

where S_{Tx} is the transmitted signal, S_{Rx} is the received signal, and f(ε, f_{d}, R) is a function of the attenuation factor ε, doppler frequency f_{d} and range R.

In some embodiments, the WTRU may determine signal difference peaks after applying FFT and/or IFFT. Further, for example, the WTRU may obtain the range and doppler peaks, e.g., IFFT of S_{diff} peak indices to detect range and FFT of S_{diff} peak indices to detect velocities.

In some embodiments, the WTRU may determine a window over which the signal difference peaks were determined after applying FFT and/or IFFT, e.g., a window where the peaks are detected after applying FFT and IFFT to S_{diff}.

In some embodiments, the WTRU may determine waveform specific measurements that include wavelet energy bins (e.g., time-frequency power distribution) and/or sensing significance measurements (e.g., one or more energy bins that contribute most to the sensing measurement).

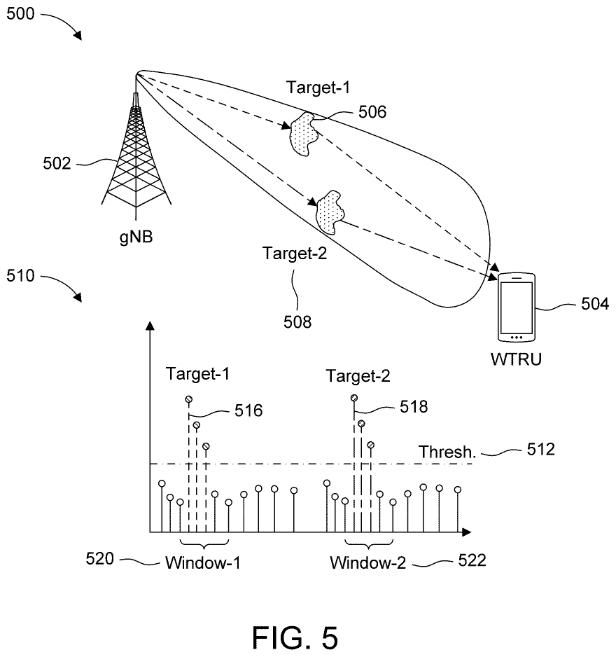

FIG. 5 is an illustrative diagram depicting channel response peaks of two targets, each defined by a peak time window, in accordance with certain embodiments.

As shown in scenario 500 of FIG. 5, a network (e.g., gNB 502) may perform sensing of a target-1 506 and a target-2 508 in connection with a WTRU 504. As shown in scenario 510 of FIG. 5, the WTRU may determine a window-1 520 associated with target-1 506 based on determining that one or more measurements 516 of target-1 are above a threshold 512. Similarly, the WTRU may determine a window-2 522 associated with target-2 508 based on determining that one or more measurements 518 of target-2 are above the threshold 512. For example, the WTRU may determine window-1 520 to be the peak time window of target-1 506 and window-2 508 to be the peak time window of target-2 522.

In some embodiments, the first set of RSs may include one or more of the supported waveform processes (e.g., transformations) indicated in the first configuration. For example the supported waveform processes indicated in the first configuration may include a type (e.g., wavelet transform, WHT, HHT, or the like) and/or corresponding parameters (e.g., wavelet function, time-frequency resources, time window, or the like).

In some embodiments, the WTRU determines the main lobe and side lobe measurements expressed as the power profiles of the estimated AoA. For example, the WTRU may obtain the design characteristics as part of the assistance information included in the configuration. Further, for example, the WTRU may obtain the autocorrelation function and/or the ambiguity function to determine the theoretical lobes information, and compare them with the measured main lobe and sidelobes. Moreover, for example, the WTRU may measure the difference between the theoretical and measured lobes information. Additionally, for example, the WTRU may obtain the peak-to-sidelobe ratio, e.g., expressed by the ratio of the maxima of the main lobe with respect to sidelobes (e.g., and/or sidelobe ambiguity).

In some embodiments, the WTRU obtains sensing measurements of targets using the measurements including at least one of the following: a set of targets, e.g., set of multipath components, angular, delay and doppler measurements, CIR, or the like); ranging measurements; velocity measurements; RCS profile; combinations of the same; or the like.

In some embodiments, the WTRU determines a set of validation measurements that are related to the waveform. For example, the validation measurements may include: certainty for each of the obtained measurements (e.g., ToA, AoA, SNR, RSRPP) and/or sensing measurement accuracy, e.g., ranging accuracy, velocity accuracy.

In some embodiments, wavelet processing may be introduced to a set of sub-carriers, where for a specific set of time-frequency resources the wavelet transformation may be introduced in accordance with the following equation:

$$x ( t ) = {\sum }_{m = 0}^{M - 1} {\sum }_{k = 0}^{{N}_{J} - 1} s ( k , m ) {e}^{j 2 π {f}_{k} t} {a}_{k , m} {ψ}_{k , m} ( t )$$

where M and Nⱼ are the time and frequency indices, a_{k,m} and ψ_{k,m} are the wavelet scaling factor and the wavelet function, T₀ is the symbol duration, s(k, m) is the m-th time index modulated by the k-th carrier index complex symbol.

In some embodiments, the WTRU may determine that the target is at a range Rr and derive the RMSE and/or an estimation of the received RS. For example, the RMSE of range estimation is represented in the following equation:

$$RMSE ( {R}_{r} ) = \sqrt{\frac{1}{{N}_{t}} {\sum }_{i = 1}^{{N}_{t}} ( {\hat{R}}_{r} [ i ] - {R}_{r} )} .$$

where \hat{R}ᵣ [i] is the i-th estimated range (out of Nₜ measurments) and Rᵣ is the actual range, and RMSE(Rᵣ) is the average difference between the estimated range estimation and the actual range.

In some embodiments, the performance of the sensing system depends on the configuration of the wavelet transform being used, e.g., Daubechies, wavelets, continuous wavelet transform, discrete wavelet transform (DWT), combinations of the same, or the like.

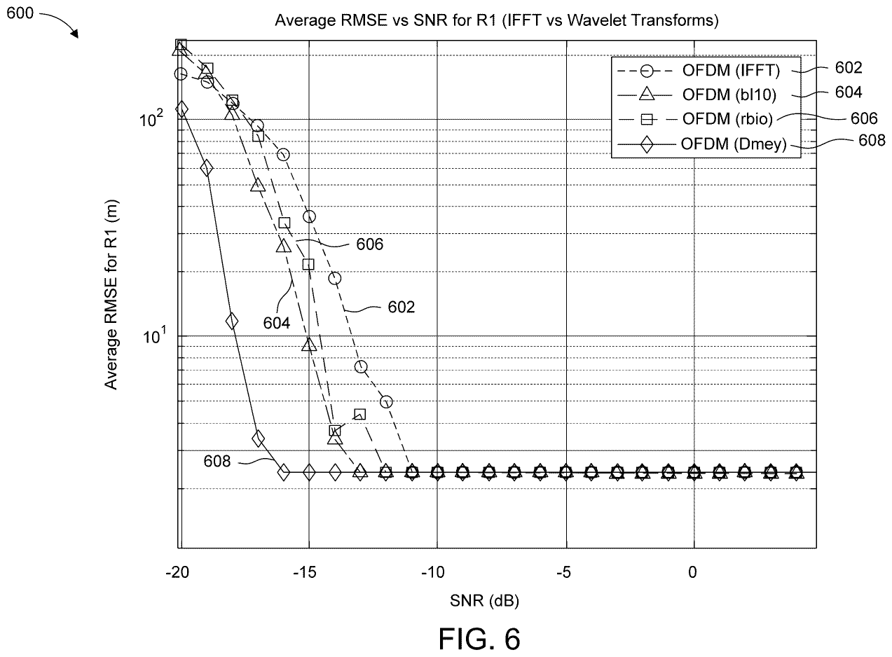

FIG. 6 is an illustrative chart 600 that depicts the average RMSE of range estimation for multiple systems that employ waveform processing, in accordance with certain embodiments. In some embodiments, the average RMSE for IFFT 608 may differ from the average RMSE for other wavelet transforms (e.g., b110 604, rbio 606, Dmey 608).

In accordance with certain embodiments of the present disclosure, waveform processing triggers are described as follows.

In certain representative embodiments, the WTRU may obtain a set of triggers for activating, updating, and/or modifying the waveform. For example, the triggers may include at least one of the following: a measured certainty for sensing measurements is below a threshold; a sensing measurement accuracy level is below a threshold; a change in location-based information; mobility measurement are above or below a threshold; ranging measurements are above or below a threshold, e.g., ranging measurement are above the maximum unambiguous range; CIR peak measurements triggers; domain resolution (e.g., time resolution, doppler resolution, frequency resolution, power resolution, angular resolution, or the like) is above or below a threshold; transmitted-to-received sensing signal mapping peaks, e.g., IFFT peak indices to detect range and FFT peak indices to detect velocities, are below a threshold; sensing resolution (e.g., time resolution, doppler resolution, frequency resolution, power resolution, angular resolution, or the like) is above or below a threshold; peak-to-sidelobe ratio is below a threshold; a difference between the main lobe and the first sidelobe is above a threshold; a mapping of the CRLB measurement given a resolution, e.g., delay resolution, range resolution, velocity resolution, or the like; range-doppler mapping peaks, e.g., IFFT peak indices to detect range and FFT peak indices to detect velocities, are below a threshold; changes in the detected range-doppler mapping peaks, e.g., location of peaks in time domain, frequency domain, or the like; waveform-specific measurements are below or above a threshold, e.g., power distribution in time-frequency of a specific portion of the wavelet bins are below or above a threshold; a quality of service, e.g., the reliability or integrity of sensing measurements for a specific sensing task, is below a threshold; a unidentified RCS profile; combinations of the same; or the like.

In some embodiments, triggers in connection with a measured certainty for sensing measurements below a threshold may include at least one of the following: a certainty of a ToA is below Thresh_toa; a certainty of TDoA is below Thresh_tdoa; a certainty of AoA is below Thresh_aoa; a certainty of SNR is below Thresh_snr; a certainty of RSRP is below Thresh_rsrp; a certainty of RSRPP goes is Thresh_rsrpp; combinations of the same; or the like.

In some embodiments, triggers in connection with a sensing measurement accuracy level being below a threshold may include a ranging accuracy being below Thresh_range and/or a velocity accuracy being below Thresh_vel.

In some embodiments, a change in location-based information may include a location type, surrounding, and/or other information describing the environment. For example, the WTRU may infer some environment information based on performing measurements (e.g., RSRP levels, received delay spread, doppler, or the like) and identifying application-level information (e.g., global positioning service (GPS) based information, or the like). Further, for example, the change in the environment may require a different waveform characteristic. Moreover, for example, rural environments have fewer obstacles, and longer ranges may be achieved, whereas the dense objects in urban environments may lead to a high number of multipath components, requiring greater focus on the mitigation of interference.

In some embodiments, triggers in connection with mobility measurements being above or below a threshold include target velocity being above a threshold and/or WTRU velocity being above or below a threshold.

In some embodiments, CIR peak measurement triggers include at least one of the following: peaks (e.g., CIR peaks) are below a threshold; a number of peaks is above or below a threshold; a difference between the delays of different peaks is above or below a threshold; an overall window of CIR peaks is above or below a threshold; combinations of the same; or the like.

In some embodiments, each of the aforementioned triggers may be potentially activated with or without processing, e.g., with processing employed at the transmitter (e.g., network) side.

In accordance with certain embodiments of the present disclosure, WTRU actions are described as follows.

In certain representative embodiments, the WTRU is configured to perform sensing measurements to employ waveform processing. For example, WTRU actions may include at least one of the following: receiving a first configuration; receiving a first set of RSs (e.g., PRSs, CSI-RSs, or the like) to perform a first set of sensing measurements; performing first sensing measurements using the received first set of RSs; obtaining a set of sensing measurements and determining whether the required performance is met; requesting and/or suggesting one or more waveform transformations based on the obtained measurements; sending a first report to the network; receiving a second configuration; receiving a second set of RSs; using waveform processing information received in the configuration to apply de-processing; performing second measurements using the received second set of RSs; determining if performance requirements were met, e.g., based on the second measurements; comparing first and second configuration metrics, e.g., peak alignment, doppler consistency, or the like, to assess improvement and/or degradation; preparing and sending a second report including the updated sensing measurements with waveform processing; reporting new and/or updated information regarding association between transformations, priority dimensions, cross-domain metrics (e.g., delay-energy mapping), or the like; combinations of the same; or the like.

For example, the WTRU may perform sensing measurement using the received first set of RS that include determining at least one of the following: received signal measurements (e.g., AoA, TOA, TDOA, RSRP, RSRPP, SNR, doppler, RCS, or the like) and their corresponding certainties; sensing estimation measurements (e.g., range and velocity of the target) with their accuracies; channel responses, e.g., CIR, CFR, PDP, or the like; peaks of the channel responses (e.g., number of peaks) and windows over which the peaks are detected (e.g., time window of received peaks, delay difference between different peaks, or the like; transmitted-to-received signal with FFT and/or IFFT applied; lobe information, e.g., peak-to-sidelobe measurements, sidelobe ambiguity, measured lobes, or the like; validation information, e.g., triggers measurements defined in the configuration; aforementioned measurements of the present disclosure; combinations of the same; or the like. Further, for example, the WTRU may determine the range and doppler peaks, e.g., IFFT of S_{diff} peak indices to detect ranges and FFT of S_{diff} peak indices to detect velocities.

For example, the WTRU may obtain a set of sensing measurements and determine whether the required performance is met, e.g., the required reliability is achieved, triggering conditions are met, ranging estimation accuracy is below a threshold. Further, for example, the WTRU obtains the peak characteristics of the received RS.

For example, the WTRU may request and/or suggest one or more waveform transformations based on obtained measurements. Further, for example, the WTRU may explicitly select the one or more waveform transformations as part of the UL signaling exchange (e.g., bits in the UCI field and indices from pre-defined lookup tables. Also, for example the WTRU may implicitly select the one or more waveform transformations by selecting certain UL resources. Moreover, for example, the WTRU may request introduction of a processing to the waveform (e.g., wavelet transformation) based on the obtained measurements associated with a set of design aspects (e.g., a specific accuracy level achieved with a specific time resolution and frequency resolution. Additionally, for example, the WTRU may request and/or suggest a specific wavelet (e.g., Daubechies wavelets (dbN), Meyer wavelet, or the like), a specific wavelet function, and/or wavelet scaling factor. Also, for example, the WTRU may determine the bandwidth requirements over which the waveform processing is required, e.g., a set of sub-carriers needed to attain a specific sensing KPI level. Even further, for example, the WTRU may determine the time window requirements over which the waveform processing is required, e.g., a set of time slots needed to attain a specific sensing KPI level; combinations of the same; or the like.

In some embodiments, the WTRU may send a first report, which may include at least one of the following; sensing measurements (e.g., range estimation, velocity estimation); received signal measurements (e.g., AoA, TDoD, ToA, doppler, or the like); recommended waveform processing, e.g., including processing type, time window, configuration, or the like.

In some embodiments, the second configuration, e.g., received by the WTRU, may include at least one of the following: a processing type, e.g., wavelet transformations; a processing configuration, e.g., a processing function including a wavelet function and scaling factor; a processing time window; processing bandwidth; a set of time frequency resources; antenna ports; correlations and/or associations (e.g., of time-delay, energy, Doppler shifts, or the like) between different waveform transforms (e.g., CIRs from FFT, wavelet, or Walsh-Hadamard); combinations of the same; or the like.

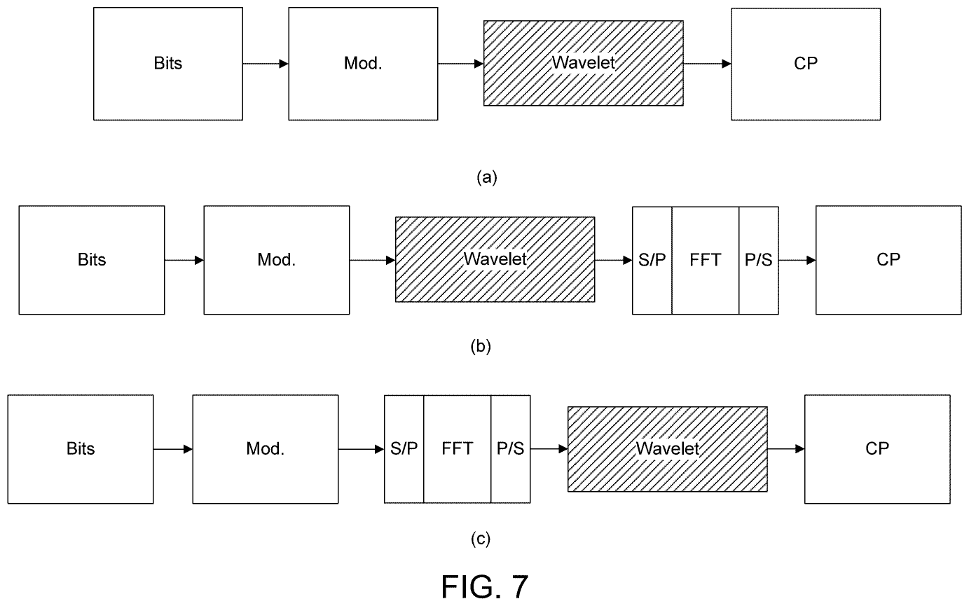

FIG. 7 is an illustrative diagram depicting wavelet waveform processing of an OFDM-based signal in accordance with certain embodiments. For example, the wavelet transform may be introduced to an OFDM-based signal as part of an OFDM signal processing chain, where bits may be modulated and a cyclic prefix may be added. Further, for example, in FIG. 7A, wavelet transformation may be introduced to the OFDM waveform after modulation and before the cyclic prefix is added. Moreover, for example, in FIG. 7B, wavelet transformation may be introduced prior to additional processing (e.g., via serial-to-parallel conversion, FFT, and parallel-to-serial conversion) and after modulation. Also, for example, in FIG. 7C, wavelet transformation may be introduced after additional processing (e.g., via serial-to-parallel conversion, FFT, and parallel-to-serial conversion) and before the cyclic prefix is added.

In some embodiments, the WTRU uses waveform processing information received in the configuration (e.g., second configuration) to apply de-processing (e.g., inverse operation of the processing applied at the transmitter). Further, in some embodiments, the WTRU may extract at least one of the following from the second configuration: the waveform processing information indicating the time window, bandwidth, sub-carrier indices, or the like to apply the inverse processing; the WTRU domain, e.g., frequency, time, or the like, as shown in FIG. 7; wavelet function, scaling factor; combinations of the same or the like. Moreover, for example, the WTRU may apply the inverse processing based on the extracted information.

In some embodiments, the WTRU may perform second measurements using the second set of RSs, including at least one of the following: updated received measurements, updated sensing measurements, updated accuracies, updated certainties, updated peak measurements, combinations of the same; or the like. Further, for example, the WTRU obtains the updated peak measurements including at least one of the following: the WTRU obtains the set of updated peaks, e.g., CIR peaks, PDP peaks above a threshold, a number of updated number of peaks; an updated delay difference between different peaks; an updated time window of the detected peaks, combinations of the same; or the like.

In accordance with certain embodiments of the present disclosure, WTRU reporting of waveform processing information is described as follows.

In certain representative embodiments, the WTRU receives from the network an indication (e.g., via RRC, MAC-CE or DCI to perform sensing measurements on a first set of received reference signals), including the triggers for activating, deactivating, and/or selecting the corresponding waveform transformation for future transmissions. For example, the WTRU may perform sensing measurements on the received RS as per the configuration and provide information and/or preferences regarding the type and parameters of waveform transformation within the sensing report.

In some embodiments, the WTRU reports to the network in a periodic, aperiodic, and semi-persistent basis, where it includes in the report a set of sensing measurements as well as a set of recommendations, suggestions, and/or indications about the waveform processing. For example, the reporting mode of the WTRU may depend on a configuration, measurement event, triggering condition, or the like.

In some embodiments, the WTRU may include at least one of the following in its report: estimated sensing measurements, e.g., target range and velocity; received and reflected signal measurements, e.g., AoA, ToA, TDoA, RSRP, RSRPP, SNR, doppler, RCS, or the like; signal measurement certainties, e.g., certainties of AoA, ToA, TDoA, or the like; channel responses (e.g., CIR, CFR, or the like) in time domain, frequency domain and/or angular domain and their corresponding power profiles (e.g., PDP); power measurements of the multipath components associated with the target, e.g., determined as the average of the power of all multipath components received from each target; peaks of the channel responses, e.g., peak CIR measurement or PDP measurement; a delay difference of peaks (e.g., of the channel responses), e.g., a number of peaks of CIR measurements or PDP measurements; a time and/or delay window over which the peaks of the target is achieved, e.g., peaks of CIR in the time domain; signal difference peaks after applying FFT and/or IFFT; lobes information, e.g., main lobe, sidelobe, or the like; validation information, e.g., measurement certainty, sensing accuracy (e.g., velocity accuracy, ranging accuracy) measurements; association of peaks and/or measurements between reports associated with different measurements; combinations of the same; or the like.

In some embodiments, the reported signal difference peaks after applying FFT and/or IFFT enable obtaining the range and doppler peaks, e.g., IFFT of S_{diff} peak indices to detect range and FFT of S_{diff} peak indices to detect velocities.

In some embodiments, lobes information may include at least one of the following: measured lobes, e.g., measured main lobe and sidelobes using the angular power profile of received signals; indicating that a peak-to-sidelobe ratio is below a specific threshold; a difference between the theoretical and measured lobes information.

In some embodiments, the WTRU includes the recommended one or more waveform transformations in the report, indicating at least one of the following: recommended waveform processing types, e.g., Fourier transformations (FFT/IFFT), wavelet transformation, WHT, HHT, or the like; recommended waveform processing parameters, e.g., wavelet functions; selection of a new transformation; a recommended set of sub-carriers to apply the waveform processing, e.g., recommendation to apply processing to a set of sub-carriers (e.g., in the frequency domain); waveform processing of a specific time window, e.g., the time window over which the processing is employed (e.g., a portion of an OFDM symbol or set of OFDM symbols); improvement metrics, e.g., updated accuracies, certainties, time window, power peaks or the like; comparative metrics, e.g., between the first and second set of configurations; associations between peaks and/or measurements between reports associated with different transformations (e.g., waveform bins obtained from wavelet transformation may be subsets of the bandwidth of the CIR measured from OFDM); anomalies or deviations such as inconsistencies or unexpected trends in the measurements (e.g., missed peaks, environment dynamics, or the like); combinations of the same; or the like.

In some embodiments, the WTRU may recommend at least one of the following options: using a new transformation, e.g., switch from FFT/IFFT to another transformation such as wavelet transformation or WHT; use a mixed transformation; combinations of the same; or the like. For example, the WTRU may select a set of sub-carriers or time-frequency resources and apply two or more transformations, e.g., include IFFT and/or wavelet transformations.

In some embodiments, the WTRU sends a report when one of the triggering events occur (e.g., any of the aforementioned event triggers), where this report may further include information about the triggering event, e.g., a specific measurement goes below or above a threshold.

In some embodiments, the WTRU indicates to the network the preferred transformation based on at least one of the following options: directly indicating the preferred transformation; referencing a pre-defined table with transformation IDs; introducing new metrics that evaluate and rank transformations based on sensing accuracy, energy efficiency, and/or suitability.

In accordance with certain embodiments of the present disclosure, WTRU reporting update is described as follows.

In certain representative embodiments, the WTRU sends a second report for the one or more waveform processing performed on the processed received signal. For example, the second report may include at least one of the following: updated estimated sensing measurements, e.g., target range and velocity, and/or the deltas of the estimated sensing measurements; updated signal measurement certainties, e.g., indicating improvements or degradations that the waveform processing has imposed on the measurements within the processed window; updated sensing accuracy measurements, e.g., velocity accuracy and ranging accuracy; updated power measurements of the multipath components associated with the target within the processed window, e.g., the change in SNR, RSRP, or the like; updated signal difference (e.g., S_{diff}) peak locations after applying FFT and/or IFFT; peaks of the channel responses within the updated window, e.g., peak CIR or PDP measurements; an updated time window over which the peaks of the target is achieved, e.g., expressed as an updated time window within the first time window or outside the previous time window reported (e.g., including updated CIR peaks, CFR peaks and/or PDP peaks of a given portion of the received set of processed signal); updated delay difference between peaks, e.g., of the channel responses, e.g., including the number of peaks of CIR measurements, PDP measurements, or the like; updated lobes information; update of validation information, e.g., measurement certainty, velocity accuracy, ranging accuracy, or the like; associations between the target measurements and the adopted waveform processing, e.g., associating between a target sensing measurement and the adopted waveform processing (e.g., including wavelet configuration, wavelet function, and scaling factor); association between the set of measurements and waveform processes, including how different processes (e.g., FFT and wavelet transform) contributed to refining key metrics (e.g., improved delay accuracy from a composite of two processes); waveform-specific measurements (e.g., wavelet-specific measurements); combinations of the same; or the like. For example, the WTRU may report (e.g., CIR) information using a first transformation and another (e.g., CIR) information using a second transformation. Further, for example, the association of the two set may be reported to the network.

In some embodiments, the updated lobes information may include at least one of the following: updated measured lobes, e.g., measured main lobe and sidelobes using the angular power profile of received signals; indications that the updated peak-to-sidelobe ratio are below a specific threshold; an updated difference between the theoretical and measured lobes information.

In some embodiments, wave-form specific measurements may include wavelet energy bins (e.g., time-frequency power distribution) and/or sensing significance measurements (e.g., significant energy portion used for sensing). Further, for example the sensing significance measurements may include one or more energy bins that contribute more to the sensing measurement.

In certain representative embodiments, a WTRU may be configure to perform a first sensing measurements using a first configuration, or set of configurations. The WTRU may receive a first set of RS with a first configuration or set of configuration with no additional waveform processing applied, e.g., conventional OFDM-based transmission with no additional processing or transformation.

In some embodiments, the WTRU may perform a first set of sensing measurements using the first RS or set of RS with a first configuration or set of configurations. These measurements may include a wide range of measurements, as listed in the above paragraphs.

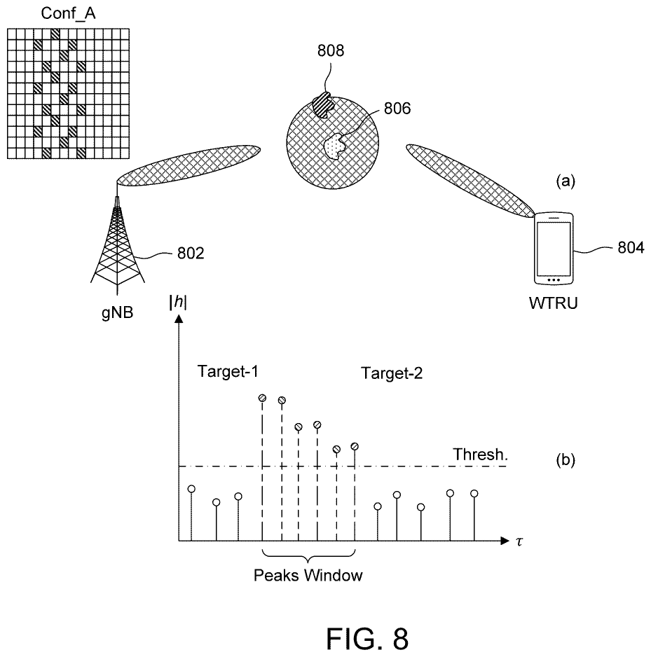

FIG. 8 is an illustrative example of a sensing measurement using a sensing configuration, in accordance with certain embodiments. FIG. 8(a) shows an example of a measurement of two targets 806, 808 with a first configuration Conf_A using a gNB 802 and a WTRU 804, and FIG. 8(b) shows the delay-power measurements. In this example, a conventional PRS signal with Conf_A configuration may be used, therefore, target 1 and target 2 may be indistinguishable from each other, e.g., a low resolution transmission.

In certain representative embodiments, a WTRU may prepare a first report, which includes a set of sensing measurements, such as the delay and power information of the received signal, where the first report Report_1 may include the following: Peaks information (e.g., Peak_1: delay_1 and power_1, Peak_2: delay_2 and power_2, Peak_3: delay_3 and power_3, . . . , Peak_N: delay_N and power_N).

After the WTRU reports a first report of measurements, which may also include an indication to switch to another configuration, as detailed in the paragraphs above, the WTRU may receive another set of RS with a second configuration or set of configurations.

In certain representative embodiments, the second configuration, or each of the configurations may include a waveform processing or set of waveform processing, e.g., a transformation or set of transformations.

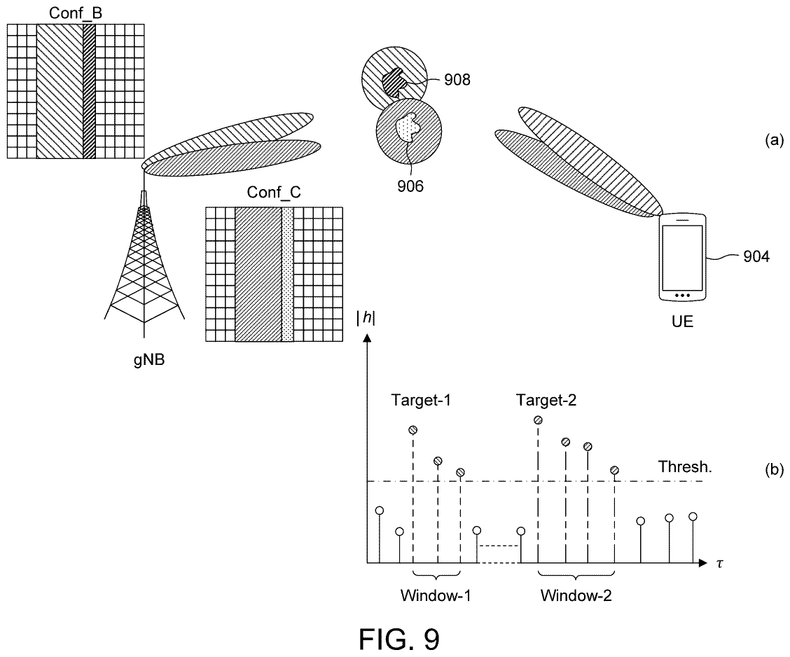

FIG. 9 is an illustrative example of a sensing measurement using a sensing configuration, in accordance with certain embodiments. In FIG. 9, a sensing measurement using a second confirmation is provided. In FIG. 9(a), the targets 906 and 908 may be the same targets 806, 808 of FIG. 8(a), where the WTUR 904 performs a first sensing measurements on a first target using a first configuration with one transformation, e.g., Conf_B, and the WTUR 904 perform a second sensing measurements on a second target using a second configuration with a second transformation, e.g., Conf_C. In this embodiment, Conf_B and Conf_C may be different to Conf_A, as shown in FIGS. 8 and 9, where Conf_B and Conf_C include waveform processing, e.g., wavelet transformation. Additionally, FIG. 9(b) shows the power and delay measurements, e.g., power peaks above a specific threshold, where target-1 measurements are obtained with Conf_B and target-2 measurements are obtained with Conf_C. In this embodiment, it can be seen that waveform processing may improve the sensing task performance, e.g., better rage resolution.

In certain representative embodiments, the WTRU may prepare a second report, which includes a set of sensing measurements obtained with a second configuration, or set of configurations, e.g., the delay and power information of the received signal, and associated with the transformation-specific measurements, e.g., wavelet time-frequency energy bins, as well as with the peaks information.

In some embodiments, the second report Report_2 may include at least one of: Report of new configuration, e.g., configuration associated with a first transformation, e.g., Transform_1; Time-frequency energy bins, e.g., wavelet time-frequency energy/power distribution; Associated sensing measurements, e.g., delay, power, phase, etc.; Associated peak measurements, number of peaks; Peaks ID, e.g., peak 1, peak 3, peak 4 etc.; Time window, e.g., includes set of delays all peaks.

In some embodiments, the WTRU may send a separate report for each new configuration, e.g., associated with a different waveform processing, e.g., transformation.

In some embodiments, the second report may include the following information: Transform_1-according to transform config 1 and associated report config 1. Report config 1 may include Time/Frequency bin arrangement and Associated power measured/phase. Associated peaks from Report_1: Peak IDs: 1, 3, 4; or Time window (i.e.: associated with the delays measurements). Transform_2-according to transform config 2, Report config 2: Time/Frequency bin arrangement, Associated power measured/phase and Associated peaks from Report_1: Peaks ID: 5, 7, 10, or Time window (i.e.: associated with the delays measurements). Up to Transform_M—according to transform config M, Report config M: Time/Frequency bin arrangement and Associated power measured/phase and Associated peaks from Report_1: Peaks ID: 4, 8, 9, or Time window (i.e.: associated with the delays measurements).

In certain representative embodiments, a WTRU may receive a first configuration from a network including measurement resources (e.g., first RS) with waveform processing information, measurement events, triggers, and reporting criteria.

In certain representative embodiments, the WTRU may perform sensing and waveform processing-related measurements on a first set of RS, which includes at peaks measurements, e.g., CIR peaks, PDP peaks.

In certain representative embodiments, the WTRU may send a first sensing report if triggers are met (e.g., sensing accuracy is below threshold) back to the network, in which it determines and suggests waveform processing type and associated parameters to be used in future transmissions.

In certain representative embodiments, the WTRU may receive a second configuration from the network including possible updated waveform processing.

In certain representative embodiments, the WTRU may perform sensing measurements on a second set RS with configured waveform.

In certain representative embodiments, the WTRU may further report the measurements with relation to the second/updated waveform process, including the updated measurements and waveform-specific measurements.

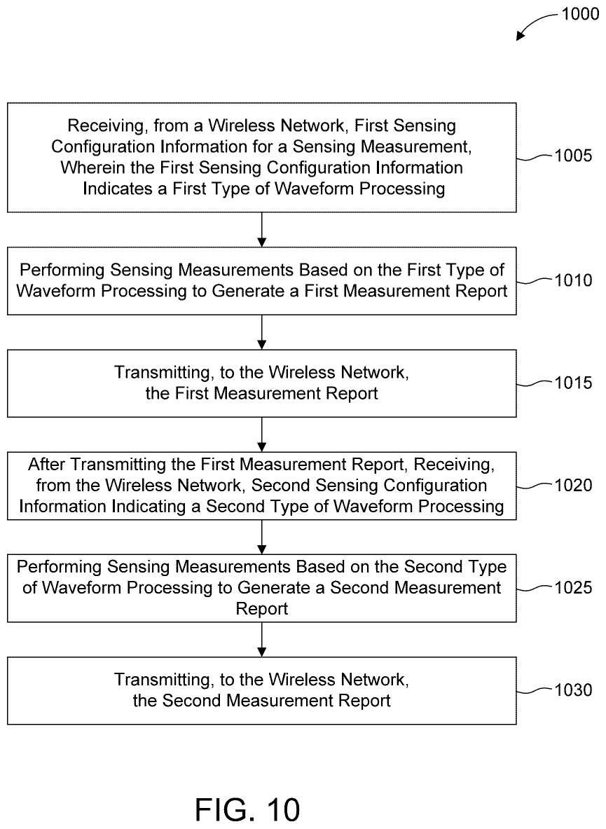

FIG. 10 illustrates a method 1000 for waveform processing for sensing according to one or more embodiments. The method 1000 may be performed by a WTRU such as any of the WTRUs 102 of FIGS. 1A-1D, the WTRU 204 of FIG. 2, the WTRU 504 of FIG. 5, the WTRU 804 of FIG. 8 or the WTRU 904 of FIG. 9. The method 1000 may include receiving 1005, from a wireless network, first sensing configuration information for a sensing measurement, wherein the first sensing configuration information indicates a first type of waveform processing. In some embodiments, the first sensing configuration may correspond to the sensing configuration in FIG. 2, 4, 8, or 9. The method 1000 may include performing 1010 sensing measurements based on the first type of waveform processing to generate a first measurement report. The method 1000 may include transmitting 1015, to the wireless network, the first measurement report. The method 1000 may include after transmitting the first measurement report, receiving 1020, from the wireless network, second sensing configuration information indicating a second type of waveform processing. In some embodiments, the second sensing configuration may correspond to the sensing configuration in FIG. 2, 4, 8, or 9. The method 1000 may further include performing 1025, sensing measurements based on the second type of waveform processing to generate a second measurement report. The method 1000 may further include transmitting 1030, to the wireless network, the second measurement report.

In some embodiments the first type of waveform processing and the second type of waveform processing may indicate at least one of a waveform processing type or a waveform transform-specific measurement.

In some embodiments, the first measurement report further may indicate a requested type of waveform processing and the second type of waveform processing corresponds to the requested type of waveform processing.

In some embodiments, the first type of waveform processing may correspond to a waveform transform applied to a reference signal (RS) prior to transmission and performing sensing measurements based on the first type of waveform processing may comprise applying an inverse waveform transform to a received RS.

In some embodiments, the first sensing configuration information may further indicate at least one trigger condition and the method further may comprise determining that the at least one trigger condition is satisfied based on sensing measurements performed based on the first type of waveform processing; and in response to determining that the at least one trigger condition is satisfied, transmitting the first measurement report.

In some embodiments, the at least one trigger condition may comprise a threshold associated with a measurement accuracy, or a measured peak value.

In some embodiments the first sensing configuration information may indicate a first reference signal (RS) associated with the sensing measurement, the second sensing configuration information may indicate a second RS associated with the sensing measurement, the first measurement report may be generated based on the first RS and the second measurement report may be generated based on the second RS.

In some embodiments, the first measurement report and/or the second measurement report may further indicate a waveform specific metric, a recommended waveform transformation, or one or more measurement associations corresponding to one or more different waveform transformations.

In some embodiments, sensing measurements performed based on the first and second types of waveform processing may comprise at least one of a measured peak value, a time window associated with one more peak values, or a difference between a transmitted signal and a received signal.

In some embodiments, the first sensing configuration information and the second sensing configuration information may be received using at least one of a Radio Resource Control (RRC), a Medium Access Control-Control Element (MAC-CE), or a Downlink Control Information (DCI).

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

What is claimed is:

1. A method performed by a wireless transmit/receive unit (WTRU), comprising:
receiving, from a wireless network, first sensing configuration information indicating a first type of waveform processing;
performing first sensing measurements based on the first type of waveform processing to generate a first measurement report;
transmitting, to the wireless network, the first measurement report;
after transmitting the first measurement report, receiving, from the wireless network, second sensing configuration information indicating a second type of waveform processing;
performing second sensing measurements based on the second type of waveform processing to generate a second measurement report; and
transmitting, to the wireless network, the second measurement report.

2. The method of claim 1, wherein the first type of waveform processing and the second type of waveform processing indicate at least one of a waveform processing type or a waveform transform-specific measurement.

3. The method of claim 1, wherein:
the first measurement report further indicates a requested type of waveform processing; and
the second type of waveform processing corresponds to the requested type of waveform processing.

4. The method of claim 1, wherein:
the first type of waveform processing corresponds to a waveform transform applied to a reference signal (RS) prior to transmission; and
performing sensing measurements based on the first type of waveform processing comprises applying an inverse waveform transform to a received RS.

5. The method of claim 1, wherein:
the first sensing configuration information further indicates at least one trigger condition; and
the method further comprises:
determining that the at least one trigger condition is satisfied based on the first sensing measurements performed based on the first type of waveform processing; and
in response to determining that the at least one trigger condition is satisfied, transmitting the first measurement report.

6. The method of claim 5, wherein the at least one trigger condition comprises a threshold associated with a measurement accuracy, or a measured peak value.

7. The method of claim 1, wherein:
the first sensing configuration information indicates a first reference signal (RS);
the second sensing configuration information indicates a second RS;
the first measurement report is generated based on the first RS; and
the second measurement report is generated based on the second RS.

8. The method of claim 1, wherein the first measurement report and/or the second measurement report further indicate a waveform-specific metric, a recommended waveform transformation, or one or more measurement associations corresponding to one or more different waveform transformations.

9. The method of claim 1, wherein the first and second sensing measurements performed based on the first and second types of waveform processing comprise at least one of a measured peak value, a time window associated with one or more peak values, or a difference between a transmitted signal and a received signal.

10. The method of claim 1, wherein the first sensing configuration information and the second sensing configuration information are received using at least one of a Radio Resource Control (RRC), a Medium Access Control-Control Element (MAC-CE), or a Downlink Control Information (DCI).

11. A wireless transmit/receive unit (WTRU) comprising:
a processer; and
a transceiver, wherein the WTRU is configured to:
receive, from a wireless network, first sensing configuration information indicating a first type of waveform processing;
perform first sensing measurements based on the first type of waveform processing to generate a first measurement report;
transmit, to the wireless network, the first measurement report;
after transmitting the first measurement report, receive, from the wireless network, second sensing configuration information indicating a second type of waveform processing;
perform second sensing measurements based on the second type of waveform processing to generate a second measurement report; and
transmit, to the wireless network, the second measurement report.

12. The WTRU of claim 11, wherein the first type of waveform processing and the second type of waveform processing indicate at least one of a waveform processing type or a waveform transform-specific measurement.

13. The WTRU of claim 11, wherein:
the first measurement report further indicates a requested type of waveform processing; and
the second type of waveform processing corresponds to the requested type of waveform processing.

14. The WTRU of claim 11, wherein:
the first type of waveform processing corresponds to a waveform transform applied to a reference signal (RS) prior to transmission; and
performing first sensing measurements based on the first type of waveform processing comprises applying an inverse waveform transform to a received RS.

15. The WTRU of claim 11, wherein:
the first sensing configuration information further indicates at least one trigger condition; and
The WTRU is further configured to:
determine that the at least one trigger condition is satisfied based on the first sensing measurements performed based on the first type of waveform processing; and
in response to determining that the at least one trigger condition is satisfied, transmit the first measurement report.

16. The WTRU of claim 15, wherein the at least one trigger condition comprises a threshold associated with a measurement accuracy, or a measured peak value.

17. The WTRU of claim 11, wherein:
the first sensing configuration information indicates a first reference signal (RS);
the second sensing configuration information indicates a second RS;
the first measurement report is generated based on the first RS; and
the second measurement report is generated based on the second RS.

18. The WTRU of claim 11, wherein the first measurement report and/or the second measurement report further indicate a waveform-specific metric, a recommended waveform transformation, or one or more measurement associations corresponding to one or more different waveform transformations.

19. The WTRU of claim 11, wherein the first and second sensing measurements performed based on the first and second types of waveform processing comprise at least one of a measured peak value, a time window associated with one or more peak values, or a difference between a transmitted signal and a received signal.

20. The WTRU of claim 11, wherein the first sensing configuration information and the second sensing configuration information are received using at least one of a Radio Resource Control (RRC), a Medium Access Control-Control Element (MAC-CE), or a Downlink Control Information (DCI).
